(19) United States
(12) Patent Application Publication
(10) Pub. No.: US 2004/0234828 A1
(43) Pub. Date: Nov. 25, 2004

(54) Electronic apparatus, fuel cell unit, and method of controlling the operation of the electronic apparatus

(75) Inventor: Akihiro Ozeki, Ome-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/805,497

(22) Filed: Mar. 22, 2004

(30) Foreign Application Priority Data
Mar. 25, 2003 (JP) 2003-083358

(51) Int. Cl. H01M 8/04

(52) U.S. Cl. 429/22; 429/13

(57) ABSTRACT

The DMFC in a fuel cell unit is a power supply unit which causes methanol held in a fuel tank to react with air (oxygen) in the DMFC cell stack to produce electrical energy. The DMFC is provided with a liquid leak sensor which senses whether or not methanol has leaked outside the regular liquid supply path. If the liquid leak sensor has sensed a liquid leak, the microcomputer informs the occurrence of the liquid leak in the DMFC to the electronic apparatus operating on the electrical power supplied from the DMFC.

### CROSS-REFERENCE TO RELATED APPLICATIONS

This application is based upon and claims the benefit of priority from prior Japanese Patent Application No. 2003-083358, filed Mar. 25, 2003, the entire contents of which are incorporated herein by reference.

### BACKGROUND OF THE INVENTION

1. Field of the Invention

This invention relates to an electronic apparatus in which a fuel cell unit having a fuel cell and a fuel holding unit for holding fuel used in the fuel cell can be installed, a fuel cell unit for the apparatus, and a method of controlling the operation of the apparatus.

2. Description of the Related Art

In recent years, various types of battery-powered portable electronic apparatuses, such as portable information terminals called personal digital assistants (PDAs) or digital cameras, have been developed and widely used.

In addition, environmental problems have lately attracted considerable attention, and environment-friendly batteries are now being actively developed. One well-known battery of this type is a direct methanol fuel cell (hereinafter, referred to as a DMFC).

In the DMFC, methanol supplied as fuel reacts with oxygen, thereby producing electrical energy. The DMFC has a structure wherein an electrolyte sandwiched between two electrodes composed of porous metal or carbon (e.g., see Hironosuke Ikeda “All about Fuel Cells,” Nihonjitsugyo Publishing Co., Ltd, Aug. 20, 2001, pp. 216-217). Since DMFCs do not generate toxic substances, there is a strong demand that they be used in the above-mentioned electronic apparatus.

Since the methanol the DMFC uses as fuel is a deleterious substance, if it should leak, measures must be taken as soon as possible. For example, U.S. Pat. No. 6,103,409 has disclosed a method of determining that a fuel leak has occurred when the pressure in the cell which causes fuel to react chemically has dropped below the threshold value, and giving a warning.

The method described in the patent document did no more than give a warning. Therefore, when the method is applied to a personal computer using the DMFC as a battery, the user cannot recognize what has happened and therefore cannot take suitable measures immediately.

### BRIEF SUMMARY OF THE INVENTION

According to an embodiment of the present invention, an electronic apparatus comprises a body, a display unit provided on the body, a fuel cell unit configured to include a fuel cell capable of supplying electrical power to the body and a fuel holding unit for holding fuel used in the fuel cell, a sensing unit configured to sense whether or not leakage of the fuel has occurred in the fuel cell unit, and a control unit configured to display information about leakage on the display unit when the sensing unit has sensed the leakage of the fuel.

### BRIEF DESCRIPTION OF THE SEVERAL VIEWS OF THE DRAWING

The accompanying drawings, which are incorporated in and constitute a part of the specification, illustrate a presently preferred embodiment of the invention, and together with the general description given above and the detailed description of the preferred embodiment given below, serve to explain the principles of the invention.

FIG. 1 shows an outward appearance of an electronic apparatus system according to an embodiment of the present invention;

FIG. 2 shows an outward appearance of the electronic apparatus system of FIG. 1, with the cover section opened;

FIG. 3 shows a schematic configuration of the electronic apparatus of the embodiment;

FIG. 4 shows a schematic configuration of a fuel cell unit of the embodiment;

FIG. 5 shows a first example of a message to warn of a fuel leak that the power supply management utility operating on the electronic apparatus system of the embodiment displays;

FIG. 6 shows how the LEDs blink under the control of a power supply controller included in the electronic apparatus of the embodiment;

FIG. 7 shows a second example of a message to warn of a fuel leak that the power supply management utility operating on the electronic apparatus system of the embodiment displays;

FIG. 8 is a first flowchart for the procedure for operation control performed in the electronic apparatus system of the embodiment;

FIG. 9 is a second flowchart for the procedure for operation control performed in the electronic apparatus system of the embodiment; and

FIG. 10 shows an example of the representation appearing when the power supply controller included in the electronic apparatus of the embodiment warns of a fuel leak by the indication of a sub-LCD in place of the blinking of the LEDs.

### DETAILED DESCRIPTION OF THE INVENTION

Hereinafter, referring to the accompanying drawings, an embodiment of the present invention will be explained.

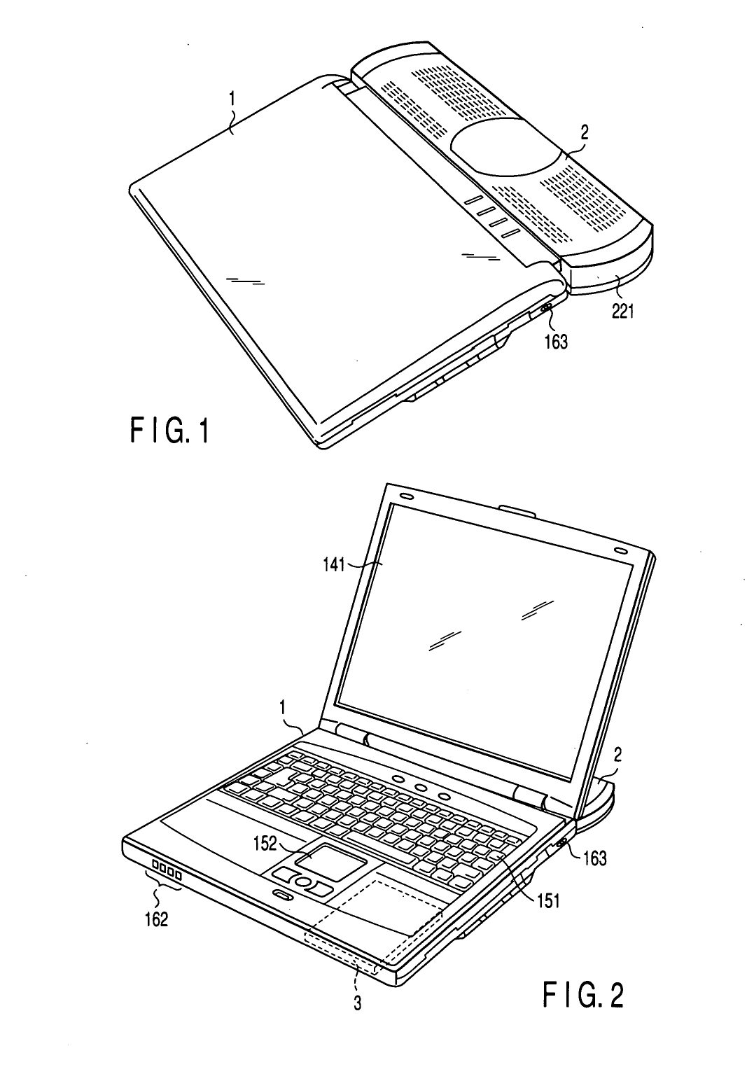

FIG. 1 shows an outward appearance of an electronic apparatus system according to an embodiment of the present invention.

As shown in FIG. 1, the electronic apparatus system comprises an electronic apparatus 1, such as a notebook personal computer, and a fuel cell unit 2 which can be installed on and removed from the back of the electronic apparatus 1. The fuel cell unit 2, which is a power supply unit for supplying power to operate the electronic apparatus 1, includes a DMFC that causes methanol supplied as fuel to react with oxygen to produce electrical energy. Methanol, fuel for the DMFC, is supplied from a cartridge fuel tank 211 detachably housed in the fuel cell unit 2. The electronic apparatus 1 further comprises an AC connector 163 which connects with an AC cord for AC power supply input.

FIG. 2 shows an outward appearance of the electronic apparatus system, with the cover section of the electronic apparatus 1 opened.

As shown in FIG. 2, the cover section of the electronic apparatus 1 is provided on the body section by a hinge mechanism in such a manner that it can be opened and closed freely. On its inner wall surface, a liquid crystal display (LCD) 141 is provided. In the body section, there are provided a keyboard 151 for entering characters, symbols, and the like into the display screen appearing on the LCD 141 and a pointing device 152 for moving a mouse cursor displayed to point at a given place on the LCD 141 and pointing out a selection. On the front of the body section, a plurality of light-emitting diodes (LEDs) 162 are provided. Moreover, a secondary cell 3 capable of charging and discharging repeatedly is built into the body section. The LEDs 162 are provided so as to be seen even when the cover section is closed.

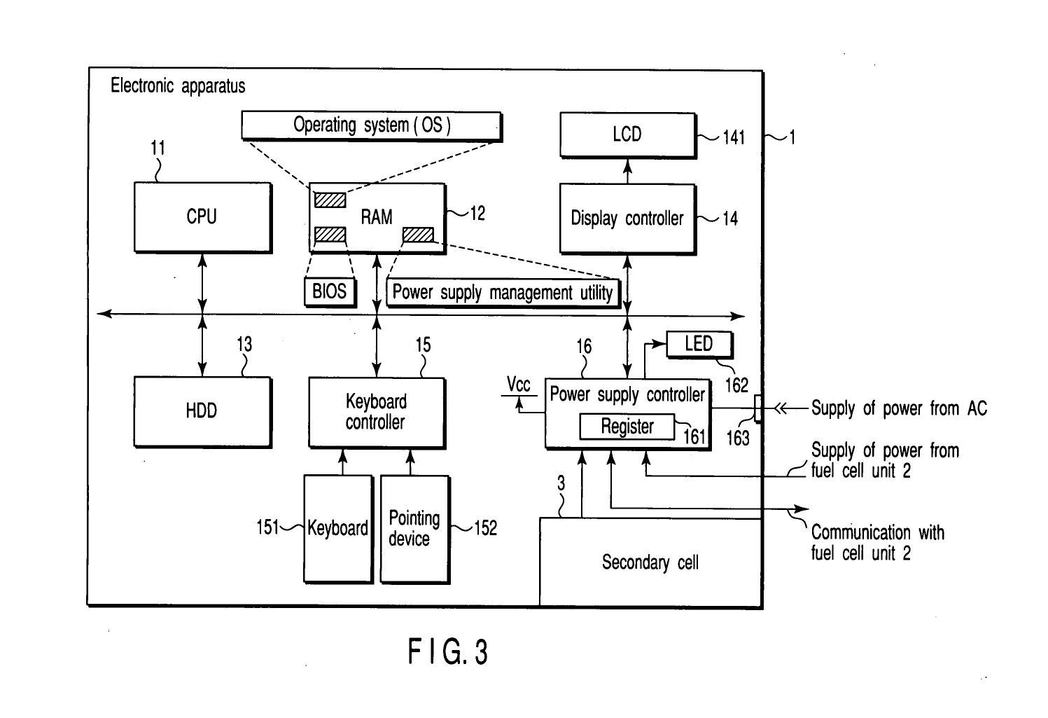

FIG. 3 shows a schematic configuration of the electronic apparatus 1.

As shown in FIG. 3, in the electronic apparatus 1, a CPU 11, a RAM 12, an HDD 13, a display controller 14, a keyboard controller 15, and a power supply controller 16 are connected to a system bus.

The CPU 11, which supervises control of the operation of the entire electronic apparatus 1, executes various types of programs, including an operating system, Basic Input/Output System (BIOS), utility software, and application software stored in the RAM 12. Power supply management utility explained later is one of a plurality of utility software programs.

The RAM 12 is a storage medium which stores various programs executed by the CPU 11 and various types of data used in those programs. The HDD 13 is a nonvolatile storage medium which stores various programs and various types of data in large amounts. The programs stored in the HDD 13 are read and copied into the RAM 12 under the control of the CPU 11 and thereafter are executed by the CPU 11.

The display controller 14, which is a device that handles the output side of a user interface provided by the electronic apparatus 1, performs control of the screen data processed by the CPU 11 so as to display the data on the LCD 141. The keyboard controller 15, which is a device that handles the input side of the user interface provided by the electronic apparatus 1, digitizes the operation of the keyboard 151 or pointing device 152 and transmits the result via an internal register to the CPU 11.

The power supply controller 16, which supplies electrical power to each section of the electronic apparatus 1, has the function of receiving power from the AC power supply, fuel cell unit 2, and secondary cell 3, and communicating with a microcomputer 21 (described later) of the fuel cell unit 2. In addition, the power supply controller 16 includes a register 161 for storing status information representing the state of the fuel cell unit 2. Referring to the status information, the power supply management utility can know the state of the fuel cell unit 2. Moreover, the power supply controller 16 has the function of performing display control of the LED 162 on the basis of the status information stored in the register 161.

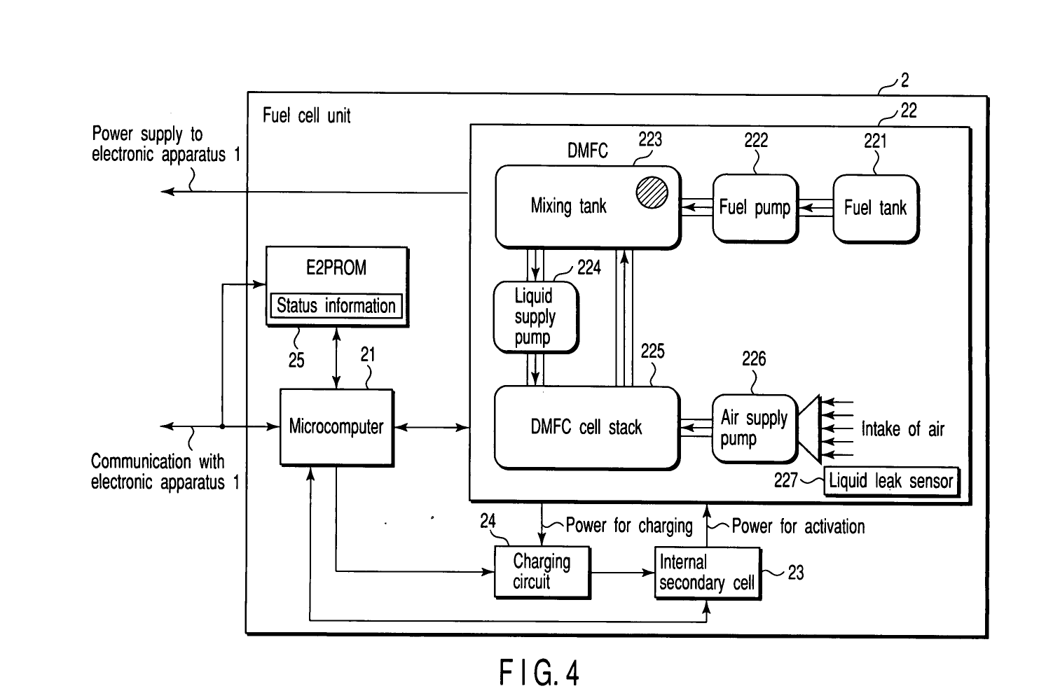

FIG. 4 shows a schematic configuration of the fuel cell unit 2.

As shown in FIG. 4, the fuel cell unit 2 has a microcomputer 21, a DMFC 22, an internal secondary cell 23, a charging circuit 24, and an E2PROM 25.

The microcomputer 21, which supervises control of the operation of the entire fuel cell unit 2, communicates with the power supply controller 16 of the electronic apparatus 1. Furthermore, the microcomputer 21, which also functions as a power supply controller in the fuel cell unit 2, performs control so as to supply the power of the internal secondary cell 23 to the DMFC 22 at the activation of the DMFC 22. When the DMFC 22 can supply power and the internal secondary cell 23 is in the low battery state, the microcomputer 21 performs control so as to charge the internal secondary cell 23 using the power generated by the DMFC 22.

The DMFC 22 is composed of a fuel tank 221, a fuel pump 222, a mixing tank 223, a liquid supply pump 224, a DMFC cell stack 225, and an air supply pump 226.

Methanol in the fuel cell tank 221 is fed to the mixing tank 223 by the fuel pump 222. The methanol is diluted to, for example, of a concentration of about 3% to 6% with the water fed back from the DMFC cell stack 225. The mixing tank 223 has the function of vaporizing the unnecessary part of the water returned from the DMFC cell stack 225 and discharging the unnecessary water from the DMFC 22.

The liquid supply pump 224 feeds the methanol in the mixing tank 223 to the DMFC cell stack 225. To the DMFC cell stack 225, the air taken in by the air supply pump 226 is fed. Then, the methanol fed by the liquid supply pump 224 reacts with oxygen in the air fed by the air supply pump 226 in the DMFC cell stack 225, thereby generating electric power supplied to the electronic apparatus 1. At this time, water is also produced. This water is returned to the mixing tank 223 through a return flow path.

In the fuel cell unit 2, a liquid leak sensor 227 is provided. The liquid leak sensor 227 senses whether or not methanol has leaked outside the regular liquid supply path in the fuel cell unit 2. When the liquid leak sensor 27 has sensed a liquid leak, the micro-computer 21 sends an interrupt signal to the power supply controller 16 of the electronic apparatus 1 and updates the status information in the E2PROM 25 so as to indicate that a liquid leak has occurred in the fuel cell unit 2. As long as a liquid leak can be sensed, any means can be used as the liquid leak sensor 227. For instance, a signal line may be run all over the inner wall surface of the fuel cell unit 2 and, when the adjacent signal lines are short-circuited, it may be determined that a liquid leak has occurred. Alternatively, a corrosive signal line may be run and, when it is cut off, it may be determined that a liquid leak has occurred.

The internal secondary cell 23, which is a lithium ion cell that can be charged and discharged repeatedly, supplies power needed by an auxiliary mechanism, including the fuel pump 222, liquid supply pump 224, and air supply pump 226, during the time from when the DMFC 22 starts to operate until more than a specific amount of power is generated. In addition, the charging circuit 24 charges the internal secondary cell 23 under the control of the microcomputer 21 by using the power generated by the DMFC 22.

The E2PROM 25 is a storage medium for storing status information indicating the state of the fuel cell unit 2. The microcomputer 21 records various states of the fuel cell unit 2, including a liquid leak in the DMFC 22 detected by the liquid leak sensor 227, in the E2PROM 25 in the form of status information.

The interface for the area in which the status information is stored in the E2PROM 25 is opened so that the status information can be referred to by the power supply controller 16 on the electronic apparatus 1 side. The power supply controller 16 stores the status information read from the E2PROM 25 in the register 161 built into the power supply controller 16.

As described above, when a liquid leak has occurred in the fuel cell unit 2, the microcomputer 21 sends an interrupt signal to the power supply controller 16 of the electronic apparatus 1. Receiving the interrupt signal, the power supply controller 16 reads the latest status information from the E2PROM 25 and stores it in the built-in register 161. At this time, if the power supply of the electronic apparatus 1 is in the on state, the power supply controller 16 informed of an interrupt notice for the cpu 11 so that transmits the update of the status information to the power supply management utility by way of the operating system. Being informed of the update of the status information, the power supply management utility acquires the latest status information stored in the register 161 of the power supply controller 16 by way of the BIOS. As a result, the power supply management utility recognizes that a liquid leak has occurred in the fuel cell unit 2.

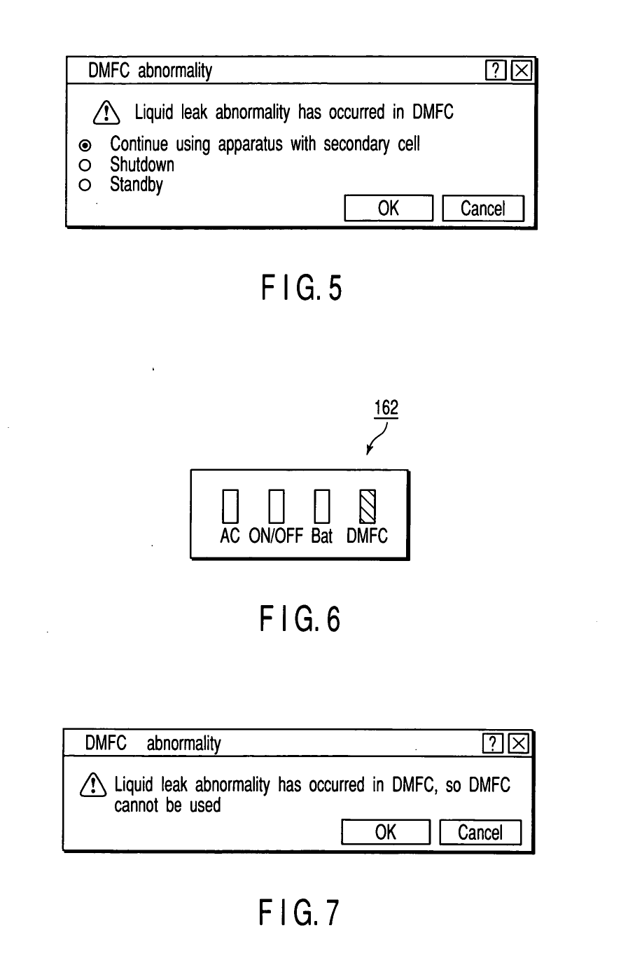

In a case where the electronic apparatus 1 is operating by the power supply from the fuel cell unit 2 when a liquid leak has occurred, the power supply management utility displays a screen in window form as shown in FIG. 5 on the LCD 141. The window representation is realized by making a request to the operating system. Hereinafter, the intervention of the operating system will be omitted in an explanation of the operation of the power supply management utility given below.

The screen shown in FIG. 5 warns the user that methanol, fuel, is leaking in the fuel cell unit 2, and prompts the user to take one of the following measures:

(1) Continue using the apparatus with the secondary cell

The power supply of the electronic apparatus 1 is changed from the fuel cell unit 2 to the secondary cell 3. The use of the electronic apparatus 1 is continued, but the DMFC 22 of the fuel cell unit 2 is stopped.

(2) Shutdown

The power supply of the electronic apparatus 1 is turned off immediately. The DMFC 22 of the fuel cell unit 2 is also stopped.

(3) Standby

After the present work environment (including context information) is saved to the HDD 13 or the like, the power supply of the electronic apparatus 1 is turned off.

When the screen appears, the user can recognize that a liquid leak has occurred in the fuel cell unit 2. Operating the pointing device 152, the user can take the measure immediately.

When the power supply of the electric apparatus 1 is off, the power supply controller 16 blinks the LEDs 162 to warn the user that a liquid leak has occurred in the fuel cell unit 2. FIG. 6 shows a representation of the LEDs 162. Seeing the blinking of the LED at the right end showing the state of the fuel cell unit 2 (DMFC), the user can recognize that a liquid leak has occurred in the fuel cell unit 2, even when the power supply of the electronic apparatus 1 is off. When the fuel cell unit 2 is removed from the electronic apparatus 1, the power supply controller 16 stops the blinking and updates the status information stored in the built-in register 161 to restore the normal condition.

Warning by the blinking of the LED 162 is not limited to a case where the power supply of the electronic apparatus 1 is off. When the power supply is on, a warning may be given together with a window representation on the LCD 141.

For instance, when the user turns on the power supply without noticing a warning by the blinking of the LEDs 162, the power supply controller 16 checks whether or not the AC power supply or the secondary cell 3 can operate the electronic apparatus 1. If the former cannot operate the latter, the power supply controller 16 does not start up the electronic apparatus 1. If the former can operate the latter, the power supply controller 16 starts up the electronic apparatus 1 by using the electric power from the AC power supply or secondary cell. After the start-up, the power supply controller 16 informed of an interrupt for the CPU 11 so that transmits the update of the status information to the power supply management utility via the operating system.

Knowing the update of the status information, the power supply management utility recognizes the occurrence of a liquid leak in the fuel cell unit 2 according to the aforementioned procedure. Then, the power supply management utility displays, for example, a screen as shown in FIG. 7 on the LCD 141 in window form. This enables the user to recognize that a liquid leak has occurred in the fuel cell unit 2. This screen is also displayed by the power supply management utility even when the power supply of the electronic apparatus 1 is on but is receiving power from a device other than the fuel cell unit 2 at the time when a liquid leak has occurred.

When the fuel cell unit 2 in which a liquid leak has occurred is installed in the electronic apparatus 1, the microcomputer 21 of the fuel cell unit 2 detects the installation and checks to see if the liquid leak sensor 2 has sensed a liquid leak or if the status information in the E2PROM 25 indicates a liquid leak. If a liquid leak has been found, the microcomputer 21 informs the power supply controller 16 of the electronic apparatus 1 of the liquid leak. Hereinafter, as described above, if the power supply of the electronic apparatus 1 is on, a warning is given by a window representation on the LCD 141. If the power supply of the electronic apparatus 1 is off, a warning is given by the blinking of the LEDs 162. The installation of the fuel cell unit 2 may be detected by the power supply controller 16 of the electronic apparatus 1 and the power supply controller 16 may acquire the status information in the E2PROM 25 actively.

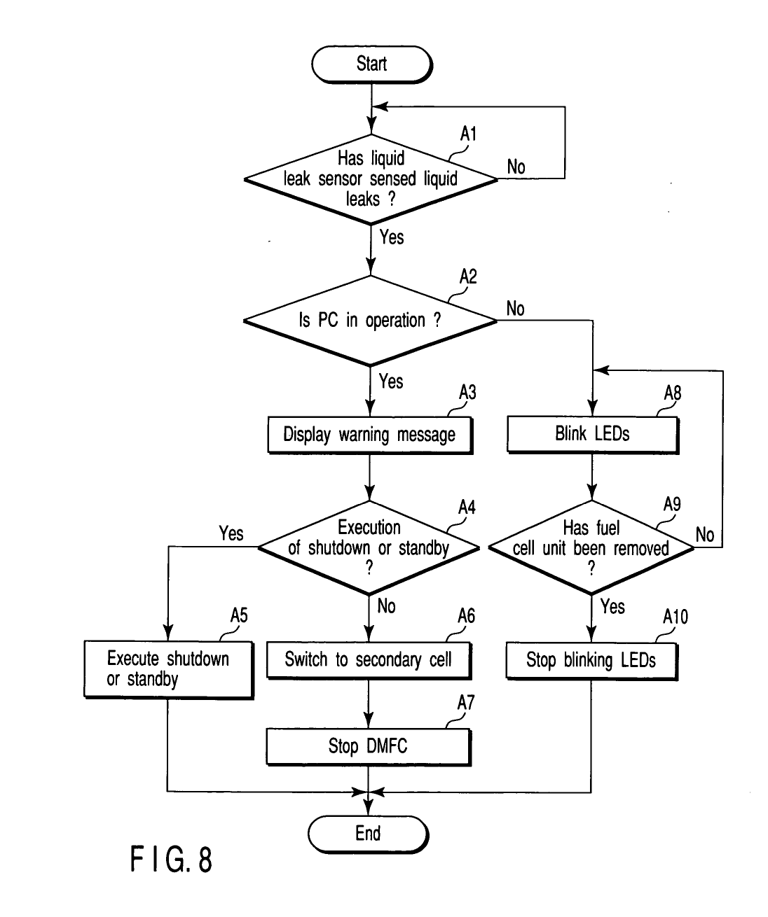

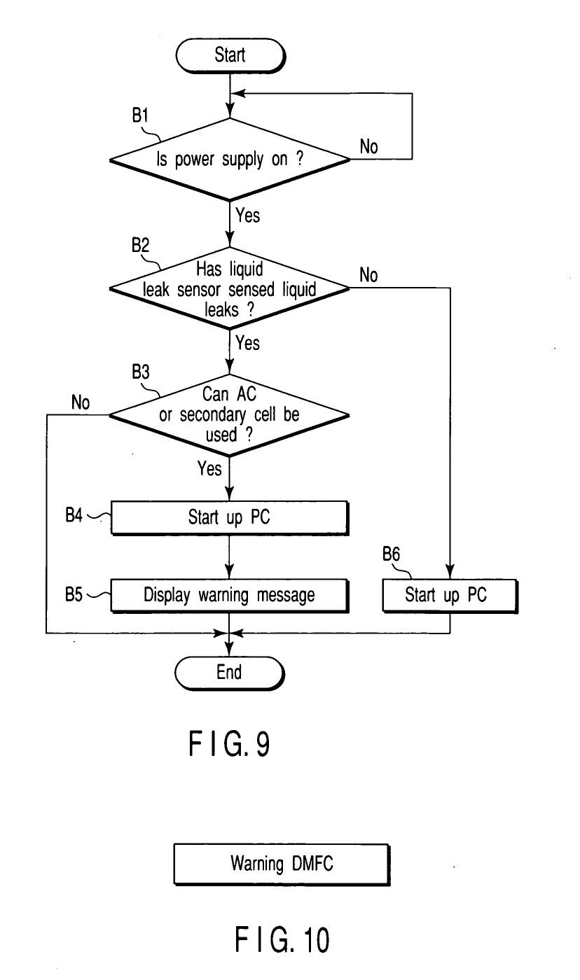

FIGS. 8 and 9 are flowcharts for the procedure for control performed in the electronic apparatus system.

When the power supply controller 16 has detected the occurrence of a liquid leak in the fuel cell unit 2 (step A1 of FIG. 8), it first checks to see if the power supply of the electric apparatus 1 is on (step A2 of FIG. 8). If the power supply is on (YES in step A2 of FIG. 8), the power supply controller 16 notifies the power supply management utility that the power supply is on. Receiving the notice, the power supply management utility displays a warning message on the LCD 141 (step A3 of FIG. 8).

When the execution of a shutdown or standby process is specified according to the representation of the warning message (YES in step A4 of FIG. 8), the power supply management utility carries out the shutdown or standby process, involving the stopping of the DMFC 22 (step A5 of FIG. 8). When the continuation of the use with the secondary cell 3 is specified (NO in step A4 of FIG. 8), the power supply management utility switches the power supply of the electronic apparatus 1 from the fuel cell unit 2 to the secondary cell 3 (step A6 of FIG. 8) and then stops the DMFC 22 (step A7).

If the power supply of the electronic apparatus 1 is off (NO in step A2 of FIG. 8), the power supply controller 16 warns of the occurrence of a liquid leak by blinking the LEDs 162 (step A8 of FIG. 8). The blinking is continued until the fuel cell unit 2 is removed. When sensing the removal of the fuel cell unit 2 (YES in step A9 of FIG. 8), the power supply controller 16 stops the blinking (step A10 of FIG. 8).

When the power supply operation has been carried out (YES in step B1 of FIG. 9), if a liquid leak has occurred in the fuel cell unit 2 (YES in step B2 of FIG. 9), the power supply controller 16 checks whether or not the AC power supply or secondary cell 3 can be used (step B3 of FIG. 9). If the AC power supply or secondary cell 3 can be used (YES in step B3 of FIG. 9), the power supply controller 16 causes the AC power supply or secondary cell 3 to start up the electronic apparatus 1 (step B4 of FIG. 9). AS a result, the power supply management utility displays a warning message on the LCD 141 (step B5 of FIG. 9). If one of the AC power supply and secondary cell 3 cannot be used (NO in step B3 of FIG. 9), the power supply controller 16 does not start up the electronic apparatus 1.

When the power supply operation has been carried out (YES in step B1 of FIG. 9), if a liquid leak has not occurred in the fuel cell unit 2 (NO in step B2 of FIG. 9), the power supply controller 16 starts up the electronic apparatus 1 with the fuel cell unit 2 (step B6).

As described above, in the electronic apparatus system, it is possible to cope with fuel leaks in the fuel cell in the fuel cell unit suitably and quickly.

In the embodiment, in the case where the power supply of the electronic apparatus is off when a liquid leak has occurred in the fuel cell unit 2, a warning of the situation is given by blinking the LED 162. However, when a sub-LCD with as small a display area as about one line is provided on the side of the housing of the electronic apparatus 1, the power supply controller 16 may display a simple representation of the warning on the sub-LCD, for example, as shown in FIG. 10.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus comprising:
a body;
a display unit provided on the body;
a fuel cell unit configured to include a fuel cell capable of supplying electrical power to the body and a fuel holding unit for holding fuel used in the fuel cell;
a sensing unit configured to sense whether or not leakage of the fuel has occurred in the fuel cell unit; and
a control unit configured to display information about leakage on the display unit when the sensing unit has sensed the leakage of the fuel.

2. The electronic apparatus according to claim 1, further comprising a secondary cell, wherein
the control unit changes the power supply from the fuel cell to the secondary cell when the sensing unit has sensed leakage of the fuel.

3. The electronic apparatus according to claim 1, further comprising a secondary cell, wherein
the control unit displays, on the display unit, information to prompt switching of the power supply from the fuel cell to the second battery when the sensing unit has sensed leakage of the fuel, and effects the switching when the switching is specified in accordance with the information.

4. The electronic apparatus according to claim 1, wherein the control unit displays, on the display unit, information to prompt shutdown of the body, and carrying out the shutdown when the shutdown is specified in accordance with the information.

5. The electronic apparatus according to claim 1, wherein the control unit displays, on the display unit, information to prompt a standby process of saving a work environment of the body and stopping the body temporarily, and carrying out the standby process when an execution of the standby process is specified in accordance with the information.

6. The electronic apparatus according to claim 1, wherein the control unit displays, on the display unit, information that the fuel cell unit cannot be used when the sensing unit has sensed leakage of the fuel at activation of the body.

7. The electronic apparatus according to claim 4, wherein the body is provided with a second display unit whose power consumption is lower than that of the display unit, and
the control unit displays information about leakage on the second display unit when the sensing unit has sensed the leakage of the fuel during stoppage of the body.

8. A fuel cell unit comprising:
a fuel cell;
a fuel holding unit configured to hold fuel used in the fuel cell;
a liquid leak sensor configured to sense leakage of the fuel; and
a notifying unit configured to notify leakage to the electronic apparatus operating on the electrical power supplied from the fuel cell when the liquid leak sensor has sensed the leakage of the fuel.

9. The fuel cell unit according to claim 8, further comprising a memory, wherein
the notifying unit stores information that the liquid leak sensor has sensed leakage of the fuel in the memory.

10. The fuel cell unit according to claim 9, further comprising a sensing unit configured to sense a presence or an absence of a connection with the electronic apparatus, wherein
the notifying unit notifies an occurrence of an abnormality when the sensing unit has sensed a connection with the electronic apparatus and the information has been stored in the memory.

11. A method of controlling the operation of an electronic apparatus in which a fuel cell unit including a fuel cell and a fuel holding unit for holding fuel used in the fuel cell can be installed, the method comprising:
sensing whether or not leakage of the fuel has occurred in the fuel cell unit; and
displaying information about leakage on a display unit included in the electronic apparatus when leakage of the fuel has been sensed.

12. The method according to claim 11, further comprising:
displaying, on the display unit, information to prompt switching of the power supply from the fuel cell to a secondary cell provided in the electronic apparatus, and
effecting the switching when the switching is specified in accordance with the information.

13. The method according to claim 11, further comprising:
displaying, on the display unit, information to prompt shutdown of the electronic apparatus, and
carrying out the shutdown when shutdown is specified in accordance with the information.

14. The method according to claim 11, further comprising:
displaying, on the display unit, information to prompt a standby process of saving a work environment of the electronic apparatus and stopping the apparatus temporarily, and
carrying out the standby process when an execution of the standby process is specified in accordance with the information.

15. The method according to claim 11, further comprising:
displaying, on the display unit, information that the fuel cell unit cannot be used when leakage of the fuel has been sensed at activation of the electronic apparatus.

16. The method according to claim 11, further comprising:
displaying information about leakage on a second display unit whose power consumption is lower than that of the display unit when the leakage of the fuel has been sensed during stoppage of the electronic apparatus.
